(19) United States
(12) Patent Application Publication
(10) Pub. No.: US 2016/0090974 A1
(43) Pub. Date: Mar. 31, 2016

(54) COMPRESSOR FOR PRODUCING A PRESSURE MEDIUM

(71) Applicant: ILLINOIS TOOL WORKS INC., Glenview, IL (US)

(72) Inventors: Martin SPINDLER, Herdwangen-Schoenach (DE); Volker PFEIFER, Sipplingen (DE); Byron Peter HUTTEN, Owingen (DE); Henry KLEMM, Uberlingen (DE)

(73) Assignee: Illinois Tool Works Inc., Glenview, IL (US)

(21) Appl. No.: 14/892,981

(22) PCT Filed: May 20, 2014
(86) PCT No.: PCT/US2014/038822

§ 371 Date: Nov. 20, 2015

(30) Foreign Application Priority Data
May 22, 2013 (DE) 10 2013 105 217.7

(51) Int. Cl. F04B 35/01; B29D 30/06; F04B 53/14; F04B 53/10; F04B 37/10; F04B 39/12

(52) U.S. Cl. CPC F04B 35/01; F04B 37/10; F04B 39/122; F04B 53/14; F04B 53/10; B29D 30/0685

(57) ABSTRACT

In the case of a compressor for generating a pressure medium, in particular for dispensing a tire sealing agent from a vessel, wherein a piston (6, 6.1) is arranged in a pressure chamber (7) so as to be movable along an axis (3) and said piston (6, 6.1) is assigned a motor (1) which effects the movement of the piston (6, 6.1), it is the intention for a drive shaft (2) of the motor (1) to be arranged in the axis (3) of the piston (6, 6.1) or parallel thereto.

The invention relates to a compressor for generating a pressure medium, in particular for dispensing a tire sealing agent from a vessel, wherein a piston is arranged in a pressure chamber so as to be movable along an axis and said piston is assigned a motor which effects the movement of the piston.

### PRIOR ART

In many situations in everyday life and in the industrial sector, there is a need for generating a pressure medium. Described here merely as an example is the possibility of dispensing a medium from a vessel, wherein the vessel is pressurized by way of a pressure medium, in particular a pressurized gas.

Reference is made, merely by way of example, to DE 10 2006 059 479 A1. Said document describes a device for dispensing tire sealing agent from a vessel, wherein the vessel can be connected to a fastener element to which any desired pressure source can be connected, and a withdrawal opening for the dispensing of tire sealing agent from the vessel into a tire can be opened up in the event of a positive pressure being generated in the vessel. Said pressure source may for example be a commercially available compressor.

For the generation of said pressure medium in a pressure chamber, it is known, for example from DE 10 2008 061 311 A1, for a piston to be arranged in a pressure chamber so as to be movable in oscillating fashion. The oscillating movement of said piston is effected by means of a double cam which is mounted on a drive shaft of a motor, wherein the motor and the drive shaft are provided perpendicular to the axis of movement of the piston. Said angular arrangement increases the structural space requirement.

### Problem

The problem addressed by the present invention is that of providing a compressor of the above-stated type which requires only little structural space, wherein the piston is however driven in the pressure chamber in an assured and uniform manner.

### Solution to the Problem

The problem is solved by virtue of a drive shaft of the motor being arranged in the axis of the piston or parallel thereto.

This means that the piston and motor are situated in a line, such that no lateral structural space is required. This has considerable advantages with regard to the arrangement of a compressor of said type, for example in a repair set.

In order that a rotary movement of the drive shaft, which in this case is arranged in the axis of movement of the piston or parallel thereto, is transmitted in an assured manner to the piston, there is mounted on said drive shaft a rotary element, the rotational movement of which is converted into a stroke movement of the piston. Here, in a first exemplary embodiment, the rotary element is curved out of the flat plane thereof at least in the circumferential region. This means that said circumference extends in an undulating or else anticlastic manner, exhibiting at least two changes in direction. Said sinusoidal change in direction makes it possible for the piston to perform the stroke movement up to a top dead center and down to a bottom dead center.

For the transmission of said curvature to the piston, it is provided that the movement of the rotary element is picked off by an object of some type. For example, it is possible for corresponding pins to be mounted on the surface of the rotary element, which pins run on the surface as the latter rotates, wherein it is however necessary in this case for a counterpressure to hold the piston or the pins in contact with the rotary element. A simpler, but not restrictive, option is for the rotary element to be encompassed at the edge by one or more sliding forks which are connected to the piston. As the rotary element rotates, said rotary element slides in a slot of the sliding fork, such that the sliding fork follows the rotational element and rises and falls. Said rising and falling movement is transmitted to the piston.

Conversely, it is also possible for the rotary element to be of planar form and to be arranged, for example, in the piston itself. In this case, it is expedient for a corresponding anticlastic or arched slotted guide to be formed into an internal surface of the piston, with at least one, preferably at least three sliding blocks that are situated on the circumference of the rotary element then running in said slotted guide. This, too, effects a raising and lowering of the piston in a corresponding cylinder which forms the pressure space or pressure chamber.

### DESCRIPTION OF THE FIGURES

Further advantages, features and details of the invention will emerge from the following description of preferred exemplary embodiments and on the basis of the drawing, in which

FIG. 1 shows a perspective view of a compressor according to the invention for generating a pressure medium;

FIG. 2 shows a perspective, partially cut-away view of the compressor according to the invention as per FIG. 1;

FIG. 3 shows a plan view of a further exemplary embodiment of a compressor for generating a pressure medium, in partial longitudinal section.

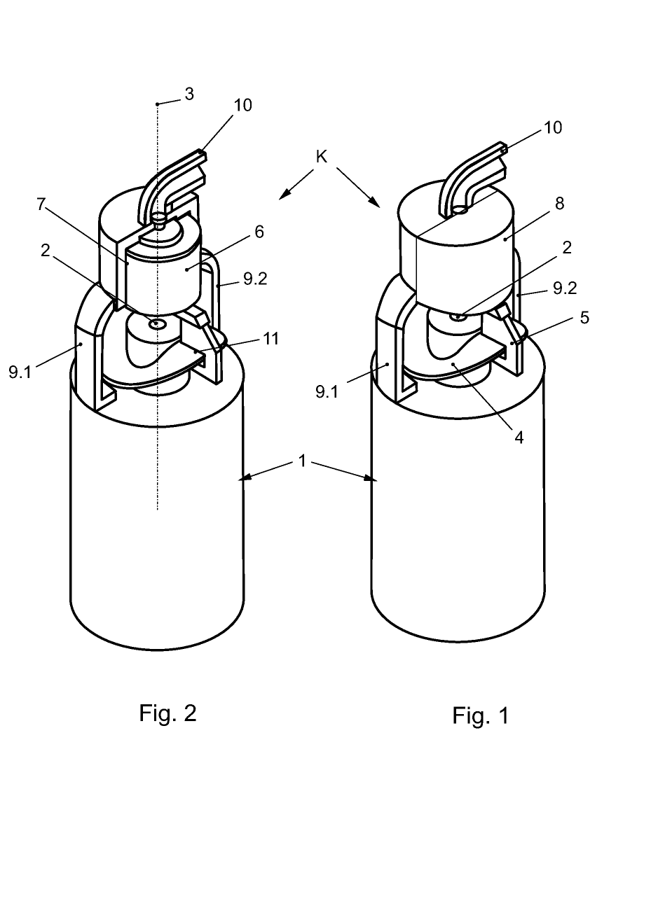

According to FIG. 1, a compressor K according to the invention for generating a pressure medium has a motor 1 which drives a drive shaft 2. Said drive shaft 2 rotates about an axis of rotation 3 illustrated by dash-dotted lines in FIG. 2.

A rotary element 4 is seated on the drive shaft 2. In the exemplary embodiment according to FIGS. 1 and 2, said rotary element 4 is of anticlastic design, that is to say, at its circumference, it extends in a curved or undulating fashion out of its own plane. In the exemplary embodiment shown, the curvature or undulating shape exhibits four changes in direction around the circumference of 360° of said rotary element 4.

Said rotary element 4 is engaged around from the outside by two opposite sliding forks 5, wherein for clarity, however, only one sliding fork 5 is illustrated. Said sliding forks 5 are connected to a piston 6 which slides, in the axis 3, in a pressure chamber 7, wherein said pressure chamber is formed by a cylinder 8. The cylinder 8 is supported against the motor 1 via supporting strips 9.1 and 9.2 and is mounted on the motor 1 in this way. A line 10 leads from the pressure chamber 7 or the cylinder 8 to a consumer for pressure medium, in particular to a bottle for dispensing a tire sealing agent, such as is presented for example in DE 20 2006 001 994 U1.

The mode of operation of the present invention is as follows:

If, for example, there is a need for tire sealing agent to be dispensed from a corresponding vessel, said vessel should accordingly be pressurized by the pressure of preferably a pressurized gas, and the tire sealing agent discharged into the tire under the pressure of the pressurized gas. The pressure medium can subsequently, for example by means of a corresponding valve, be diverted directly into the tire in order to inflate the tire.

According to the present invention, a corresponding pressure medium, in particular a pressurized gas, is generated in the pressure chamber 7 in that the piston 6 is moved in oscillating fashion in the pressure chamber 7 along the axis 3, and in this way, for example, inducted air that is compressed in the pressure chamber 7 is transported through the line 10 to a vessel.

The movement of the piston 6 is generated by means of the motor 1 and the rotary element 4. The motor 1 sets the drive shaft 2 in rotational motion, and said rotational motion is transmitted to the rotary element 4. The sliding fork is preferably configured so as to be static at least relative to the rotary element 4, such that, owing to the fact that the rotary element 4 moves in a corresponding slot 11 of the sliding fork and correspondingly raises and lowers the sliding fork 5 axially parallel to the axis 3, said sliding fork transmits said movement to the piston 6, which performs said movement in the pressure chamber 7. In this way, an axially parallel transmission of the rotary movement of the drive shaft 2 to the piston 6 is realized, such that the motor 1 can be arranged in the direction of the piston, whereby a space problem that arises in many situations is solved.

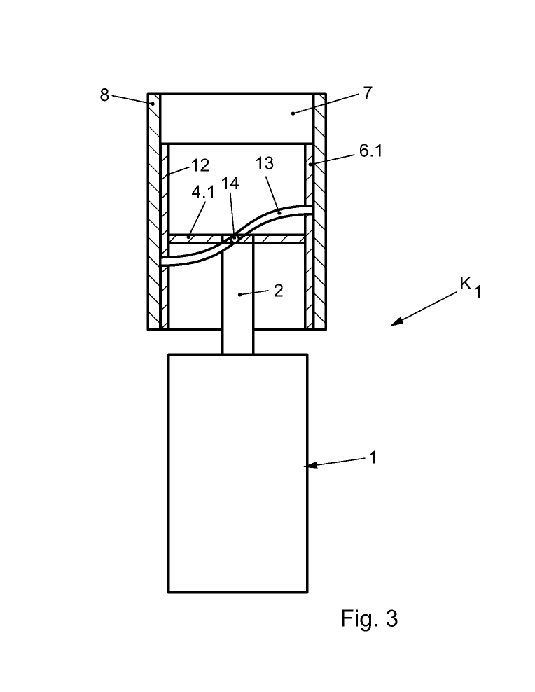

A similar effect is also achieved by means of the exemplary embodiment of a compressor K1 according to FIG. 3. In this case, too, a motor 1 drives, by way of its drive shaft 2, a rotary element 4.1, which is however of disk-shaped or ring-shaped form and does not have a curvature. Furthermore, said rotary element 4.1 is situated in the interior of the piston 6.1 that slides in the pressure chamber 7.

In this case, a groove or slotted guide 13 is formed into an internal surface 12 of the piston 6.1, said groove or slotted guide extending in an anticlastic or curved configuration, similarly to the circumference of the rotary element 4. Said groove or slotted guide also preferably exhibits at least two, but preferably four, changes in direction.

Said slotted guide 13 is engaged into by a sliding block, preferably two mutually opposite sliding blocks 14, which run in said slotted guide 13 as the rotary element 4.1 rotates. This results in a raising and lowering of the piston 6.1.

List of reference numerals

| | |
|---|---|
| 1 | Motor |
| 2 | Drive shaft |
| 3 | Axis |
| 4 | Rotary element |
| 5 | Sliding fork |
| 6 | Piston |
| 7 | Pressure chamber |
| 8 | Cylinder |
| 9 | Supporting strip |
| 10 | Line |
| 11 | Slot |
| 12 | Internal surface |
| 13 | Slotted guide |
| 14 | Sliding block |
| 15 | |
| 16 | |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| 67 | |
| 68 | |
| 69 | |
| 70 | |
| 71 | |
| 72 | |
| 73 | |
| 74 | |
| 75 | |
| 76 | |
| 77 | |
| 78 | |
| 79 | |

1. A compressor for generating a pressure medium, in particular for dispensing a tire sealing agent from a vessel, the compressor comprising:
a piston (6, 6.1) arranged in a pressure chamber (7) so as to be movable along an axis (3) and said piston (6, 6.1) is assigned a motor (1) which effects the movement of the piston (6, 6.1), wherein a drive shaft (2) of the motor (1) is arranged in the axis (3) of the piston (6, 6.1) or parallel thereto.

2. The compressor as claimed in claim 1, further comprising a rotary element (4, 4.1) that is operatively connected the piston (6, 6.1), the rotary element mounted to the drive shaft (2) of the motor (1).

3. The compressor as claimed in claim 2, wherein the rotary element (6, 6.1) comprises a disk or a ring.

4. The compressor as claimed in claim 2, wherein the rotary element (6) is curved out of the plane thereof.

5. The compressor as claimed in claim 4, wherein the rotary element (6) includes at least two changes in direction along its circumference.

6. The compressor as claimed in claim 2, wherein the rotary element (6) is encompassed from the outside by at least one sliding fork (5) which is connected to the piston (6).

7. The compressor as claimed in claim 6, wherein two opposite sliding forks (5) encompass the rotary element (6) from the outside.

8. The compressor as claimed in claim 2, wherein a circumference of the rotary element (4.1) is assigned at least one sliding block (15) which runs in a slotted guide (13) in an internal surface (12) of the piston (6.1).

9. The compressor as claimed in claim 8, wherein the slotted guide (13) is of undulating or anticlastic configuration.

10. The compressor as claimed in claim 8, wherein the slotted guide (13) extends in undulating fashion with at least one change in direction.
